(19) United States
(12) Patent Application Publication
(10) Pub. No.: US 2024/0388471 A1
(43) Pub. Date: Nov. 21, 2024

(54) Vehicle PHY configuration depending on cable length

(71) Applicant: Marvell Asia Pte Ltd, Singapore (SG)

(72) Inventors: Seid Alireza Razavi Majomard, Belmont, CA (US); Ragnar Hlynur Jonsson, Aliso Viejo, CA (US); David Shen, Saratoga, CA (US)

(21) Appl. No.: 18/644,221

(22) Filed: Apr. 24, 2024

Related U.S. Application Data
(60) Provisional application No. 63/467,003, filed on May 16, 2023.

(51) Int. Cl. H04L 12/64; H04L 67/12

(52) U.S. Cl. CPC H04L 12/6418; H04L 67/12; H04L 2012/6491

(57) ABSTRACT

An in-vehicle Ethernet network for data communication within a vehicle, includes a plurality of cables, a first Ethernet transceiver and a second Ethernet transceiver. The plurality of cables includes at least a first cable having a first length, and a second cable having a second length shorter than the first length. The first Ethernet transceiver is coupled to the longer cable and is configured to communicate first symbols over the longer cable at a first baud rate that is commensurate with the first cable length. The second Ethernet transceiver is coupled to the shorter cable and is configured to communicate second symbols over the shorter cable at a second baud rate that is commensurate with the second cable length and lower than the first baud rate.

### CROSS-REFERENCE TO RELATED APPLICATIONS

This application claims the benefit of U.S. Provisional Patent Application 63/467,003, filed May 16, 2023, whose disclosure is incorporated herein by reference.

### FIELD OF THE DISCLOSURE

The present disclosure relates generally to network communication, such as network communication in motor vehicles, and particularly to methods and systems for configuring the baud rate and other parameters of physical-layer (PHY) transceivers based on cable length.

### BACKGROUND

Physical Links that connect between elements of a communication network are typically accessed using Physical-layer (PHY) transceivers.

Aspects of PHY transceivers that are applicable in automotive Ethernet networks are described, for example, in an IEEE Standard for Ethernet—Amendment 8: Physical Layer Specifications and Management Parameters for 2.5 Gb/s, 5 Gb/s, and 10 Gb/s Automotive Electrical Ethernet.

The description above is presented as a general overview of related art in this field and should not be construed as an admission that any of the information it contains constitutes prior art against the present patent application.

### SUMMARY

An embodiment that is described herein provides an in-vehicle Ethernet network for data communication within a vehicle, including a plurality of cables, a first Ethernet transceiver and a second Ethernet transceiver. The plurality of cables includes at least a first cable having a first length, and a second cable having a second length shorter than the first length. The first Ethernet transceiver is coupled to the longer cable and is configured to communicate first symbols over the longer cable at a first baud rate that is commensurate with the first cable length. The second Ethernet transceiver is coupled to the shorter cable and is configured to communicate second symbols over the shorter cable at a second baud rate that is commensurate with the second cable length and lower than the first baud rate.

In some embodiments, the shorter cable provides one of: (i) a link between a switch and a processor of the in-vehicle Ethernet network, (ii) a link between a switch and a storage device of the in-vehicle Ethernet network, and (iii) a link between a switch and a sensor device of the in-vehicle Ethernet network. In other embodiments, the longer cable provides a link between two switches of the in-vehicle Ethernet network. In yet other embodiments, the first Ethernet transceiver is configured to modulate the first symbols for transmission over the first cable with a first number of bits, and the second Ethernet transceiver is configured to modulate the second symbols for transmission over the second cable with a second number of bits higher than the first number of bits.

In an embodiment, each of the first and second Ethernet transceivers is configured to support both the first baud rate and the second baud rate, and is pre-configured to communicate at the first or second baud rate, respectively. In another embodiment, the first Ethernet transceiver is configured to support only the first baud rate, and the second Ethernet transceiver is configured to support only the second baud rate. In yet another embodiment, the first Ethernet transceiver has a first signal processing capacity, and the second Ethernet transceiver has a second signal processing capacity different from the first signal processing capacity.

In some embodiments, the first Ethernet transceiver includes a first echo canceler having a first number of taps, and the second Ethernet transceiver includes a second echo canceler having a second number of taps smaller than the first number of taps. Inn other embodiments, the first Ethernet transceiver includes a first receiver includes a first equalizer having a first number of taps, and the second Ethernet transceiver includes a second receiver including a second equalizer having a second number of taps smaller than the first number of taps. In yet other embodiments, the first Ethernet transceiver includes multiple echo cancelers operating in parallel requiring a first level of complexity, and the second Ethernet transceiver includes a non-parallel echo canceler requiring a second level of complexity lower than the first level of complexity.

In an embodiment, the first Ethernet transceiver includes multiple equalizers operating in parallel requiring a first level of complexity, and the second Ethernet transceiver includes a non-parallel equalizer requiring a second level of complexity lower than the first level of complexity. In another embodiment, the first cable and the second cable are of a same cable type.

There is additionally provided, in accordance with an embodiment that is described herein, a method for data communication within a vehicle, including, in an in-vehicle Ethernet network that includes at least a first cable having a first length, and a second cable having a second length shorter than the first length, communicating first symbols over the longer cable, by a first Ethernet transceiver that is coupled to the longer cable, at a first baud rate that is commensurate with the first cable length. Second symbols are communicated over the shorter cable, by a second Ethernet transceiver that is coupled to the shorter cable, at a second baud rate that is commensurate with the second cable length and lower than the first baud rate.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates an automotive communication system in which PHY transceivers are configurable depending on cable length, in accordance with an embodiment that is described herein;

FIGS. 2A-2D are block diagrams that schematically illustrate example schemes for PHY connectivity in the communication system of FIG. 1; and

FIG. 3 is a flow chart that schematically illustrates a method for configuring a PHY transceiver in an automotive network, in accordance with an embodiment that is described herein.

### DETAILED DESCRIPTION OF EMBODIMENTS

An automotive Ethernet network serves for communication among end devices in the vehicle, such as between a central processor and sensors of various types. In the vehicle network, physical cables provide point-to-point communication links. The cables may comprise, for example, twisted-pair cables and coax cables, shielded or unshielded.

An automotive communication network may be configured in various topologies. For example, modern automotive networks may be configured in a “zonal topology” in which several interconnected gateways are located at selected zones of the vehicle, and the end devices are connected to the zonal gateways. A gateway in the zonal topology may comprise, for example, a network switch such as an Ethernet switch, a network aggregator, a local hub, or a processor.

In the zonal topology, the end devices in each zone are located close to the common gateway, and therefore may be connected to that gateway using relatively short cables, e.g., on the order of 2-5 meters. In contrast, the gateways reside remotely from one another in the vehicle, and therefore gateway-to-gateway connections typically require longer cables, e.g., on the order of 10-15 meters. In the description that follows, the physical links within a zone are also referred to as “zonal links”, and the physical links connecting between gateways are referred to as “interzonal links”.

A physical link in the network may be accessed via a Physical-layer (PHY) transceiver, which transmits and receives, over the physical link, symbols that modulate data bits. The number of bits per symbol (denoted Nb) is also referred to herein as the “modulation order”.

The rate of sending (or receiving) symbols over the cable is referred to as a “symbol rate” or “baud rate” (denoted BR). The rate of transferring data bits over the cable is referred to as a “data rate” (denoted DR). The data rate is related to the baud date as given by: DR=BR·Nb. This means that the same data rate can be achieved with different combinations of baud rate and modulation orders. For example, with a Pulse Amplitude Modulation (PAM) PAM2 modulation scheme (Nb=1), the baud rate equals the data rate. By using a PAM4 modulation scheme (Nb=2) the baud rate may be reduced by half to retain the same data rate.

The amount of power consumed by a PHY transceiver typically increases with the baud rate at which the PHY operates. Consequently, communication using low baud rates may be advantageous in terms of reducing power consumption. Low baud rates may also allow reducing PHY complexity and improving immunity to electromagnetic interference. In the disclosed embodiments, as will be described below, a PHY transceiver is configurable to communicate at a baud rate that depends on the cable length.

A signal traversing a physical link is attenuated depending on the cable length. Specifically, for a given modulation scheme, with a longer cable, the attenuation of the cable increases, and therefore the receiver performance decreases. Consequently, the modulation order for communicating over a short cable can be set higher than the modulation order for communicating over a long cable, without compromising reception performance.

In view of the foregoing, a PHY transceiver may be configured to a high baud rate and a low-order modulation scheme when communicating over a long cable, or to a lower baud rate (e.g., for reducing power consumption while maintaining high immunity to noise at a high data rate) and a higher-order modulation scheme when communicating over a shorter cable, with comparable data rates and reception performance despite reduced robustness against noise. This means that, in an embodiment, different PHY transceivers are used for different cable length, to optimize the size and cost of low-reach PHY transceivers.

The PHYs in automotive Ethernet networks currently used typically are designed for a worst-case cable length of 15 meters. As a result, a low-order modulation scheme and a high baud rate are used for all cable lengths, resulting in high power consumption due to the high baud rate. Since in the zonal topology the zonal physical links are much shorter than 15 meters (e.g., 2-5 meters), the baud rate specified for 15 meters may be reduced, at least for the zonal physical links (e.g., to reduce power consumption while maintaining acceptable immunity to noise).

In summary, in the disclosed embodiments, a PHY transceiver in the vehicle is configured to communicate at a baud rate that depends on the cable length to which the PHY connects. The shorter the cable, the more the baud rate can be decreased, and the power consumption reduced. Moreover, for the shorter physical links, the modulation order may be increased, even though the higher modulation orders may be more susceptible to noise, to compensate for the reduction in data rate that would arise from the reduced baud rate, if not compensated, while retaining receiver performance.

Consider an embodiment of an in-vehicle Ethernet network for data communication within a vehicle includes a plurality of cables including at least a first cable having a first length, and a second cable having a second length shorter than the first length, a first Ethernet transceiver and a second Ethernet transceiver. The first Ethernet transceiver is coupled to the longer cable and is configured to communicate first symbols over the longer cable at a first baud rate that is commensurate with the first cable length. The second Ethernet transceiver is coupled to the shorter cable and is configured to communicate second symbols over the shorter cable at a second baud rate that is commensurate with the second cable length and lower than the first baud rate. By using a lower baud rate for communication over the shorter cables, the power consumption can be reduced considerably.

In the present context, the phrase “a baud rate that is commensurate with a cable length” means that the baud rate and underlying modulation order are suitable for communication over the cable at a required data rate and at an acceptable receiver performance”.

The first (longer) and second (shorter) cables in the in-vehicle Ethernet network may provide communication links between various elements in the in-vehicle network. For example, in an example zonal topology, the shorter cable provides one of: (i) a link between a switch and a processor of the in-vehicle Ethernet network, (ii) a link between a switch and a storage device of the in-vehicle Ethernet network, and (iii) a link between a switch and a sensor device of the in-vehicle Ethernet network, and wherein the longer cable provides a link between two switches of the in-vehicle Ethernet network.

Currently used standards related to Ethernet PHY transceivers are typically specified for cables much longer than automotive zonal links. Consequently, the PHY transceivers currently used for the zonal links have larger size, cost and power consumption than necessary.

The reduction in baud rate for the shorter cables typically results in a reduced data rate. In some embodiments, to compensate for the reduction in data rate, a higher order modulation scheme may be used over the shorter cables. For example, the first Ethernet transceiver is configured to modulate the first symbols for transmission over the first cable with a first number of bits, and the second Ethernet transceiver is configured to modulate the second symbols for transmission over the second cable with a second number of bits higher than the first number of bits. It is noted that the higher modulation orders are typically less immune to noise, but this reduced robustness is balanced by the shorter length of the physical cable.

In some embodiments, the Ethernet transceivers support a flexible baud rate configuration. In such embodiments, each of the first and second Ethernet transceivers is configured to support both the first baud rate and the second baud rate, and is pre-configured to communicate at the first or second baud rate, respectively. In alternative embodiments, the first Ethernet transceiver is configured to support only the first baud rate, and the second Ethernet transceiver is configured to support only the second baud rate.

The signal processing capacity of an Ethernet PHY transceiver typically increases with the underlying baud rate. Consequently, an Ethernet transceiver connected to a shorter cable may require lower signal processing capacity, which results in reduced power consumption, and smaller chip area.

The Ethernet transceiver typically comprises an echo canceler for mitigating reflections of the transmitted signal, and an equalizer for reducing Inter Symbol Interference (ISI). Each of the echo canceler and equalizer typically is implemented using a filter having multiple taps. Since reducing the baud rate improves the performance of the echo canceler and equalizer, a smaller number of taps may be advantageously used in the echo canceler and/or equalizer, in Ethernet transceivers communicating over the shorter cables.

In an embodiment, to accommodate the (high) first baud rate, the first Ethernet transceiver comprises multiple echo cancelers operating in parallel requiring a first level of complexity. In this embodiment, due to the reduced baud rate, the second Ethernet transceiver comprises a non-parallel echo canceler requiring a second level of complexity lower than the first level of complexity.

In an embodiment, to accommodate the (high) first baud rate, the first Ethernet transceiver comprises multiple equalizers operating in parallel requiring a first level of complexity. In this embodiment, due to the reduced baud rate, the second Ethernet transceiver comprises a non-parallel equalizer requiring a second level of complexity lower than the first level of complexity.

The cables used in the in-vehicle Ethernet network may be of various cable types. In one embodiment, the first cable and the second cable are of the same cable type.

In the disclosed techniques, an Ethernet transceiver operates at a baud rate that depends on the cable length. For example, for short cables, a lower baud rate may be used, compared to longer cables. In addition, for short cables a higher-order modulation scheme can be used to compensate for the reduction in data rate associated with the reduced baud rate. Using a zonal topology with short zonal cables and communicating at a low baud rate are advantageous in terms of reduced power consumption, reduced complexity, applicable with lower quality and cheaper cables, and smaller chip area.

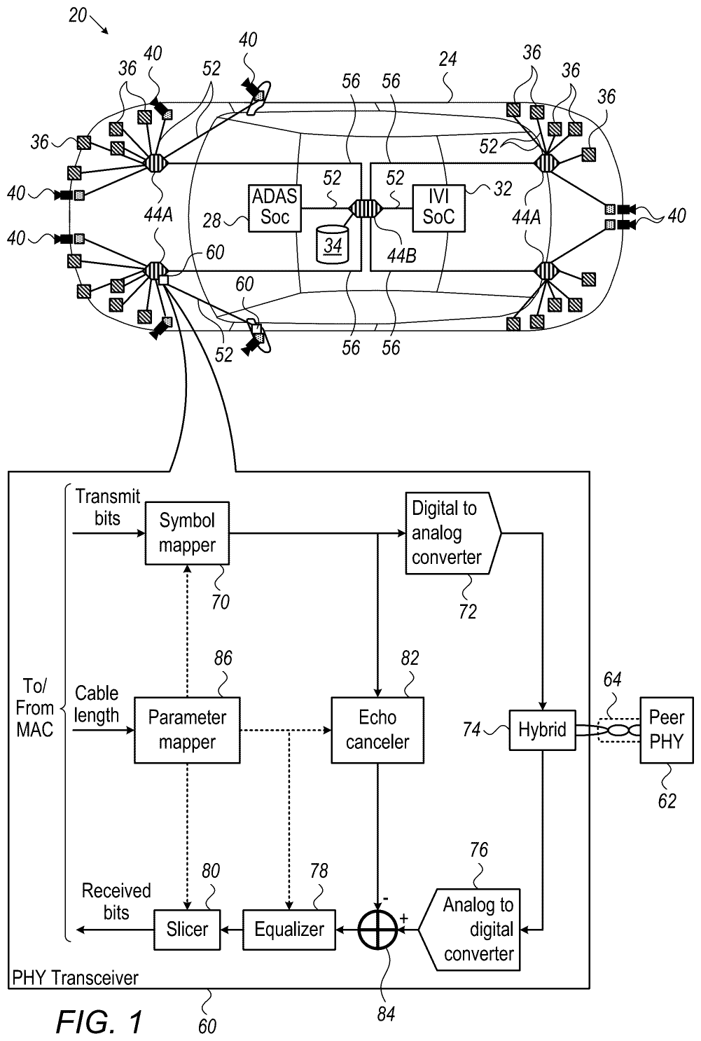

FIG. 1 is a block diagram that schematically illustrates an automotive communication system 20 in which PHY transceivers are configurable depending on cable length, in accordance with an embodiment that is described herein.

Communication system 20 is installed in a vehicle 24, in an embodiment, and provides in-vehicle connectivity between various devices including central processors such as an Advanced Driver-Assistance System (ADAS) 28 and In-Vehicle Infotainment (IVI) system 32, a storage device 34, sensors and Electronics Control Units (ECUs) 36 and cameras 40. An ECU may be used for controlling one or more sensors and for collecting data from the sensors. ADAS 28 may send control messages to the sensors and receive sensor data from the sensors over the automotive network.

In various embodiments, sensors 36 may comprise any suitable types of sensors. Several non-limiting examples of sensors comprise, video cameras, velocity sensors, accelerometers, audio sensors, infra-red sensors, radar sensors, lidar sensors, ultrasonic sensors, rangefinders or other proximity sensors, and the like.

The various devices communicating over the in-vehicle network may be clustered into separate zones, wherein each zone corresponds to devices that physically reside close a common gateway in the vehicle, such as gateways 44A and 44B. In the example of FIG. 1, separate zones comprising sensors 36 and cameras 40 are connected to gateways 44A around the front-left, front-right, back-left, and back-right corners of the vehicle. As another example, a zone associated with central gateway 44B includes ADAS 28, IVI system 32 and storage device 34. The topology depicted in FIG. 1 is not mandatory, and in alternative embodiments other suitable zonal topologies can also be used. For example, in another zonal topology, different processors may connect to different gateways and thus belong to different zones.

The various elements of the in-vehicle network are connected to one another using cables of suitable lengths, which cables are also referred to as “physical links” or simply “links” for brevity.

In the example of FIG. 1, each gateway 44A connects via zonal links 52 to sensors 36 and cameras 40 belonging to that zone. Similarly, gateway 44B connects via zonal links 52 to ADAS 28, IVI 32 and storage device 34 in a separate zone. Gateways 44A additionally connect via interzonal links 56 to gateway 44B. Gateways 44A and 44B may comprise, for example, an Ethernet network switch. Alternatively, the gateways may comprise a network aggregator, a local hub, or a processor. In the depicted zonal architecture, due to the spatial zone clustering, zonal links 52 are much shorter than interzonal links 56.

Depending on the applicable Ethernet standard, links 52 and links 56 may comprise any suitable physical medium. In the embodiments described herein, although not necessarily, each link 52 and each link 56 comprises a single pair of wires, e.g., a single twisted-pair link that is optionally shielded. Alternatively, other types of links such as (but not limited to) coax cables, bundle cables or a bus may also be used.

Each of zonal links 52 and each of interzonal links 56 is accessed using physical-layer (PHY) transceivers 60, coupled at each physical link end. For the sake of clarity, FIG. 1 depicts only one pair of PHYs (60) used for accessing a zonal link 52 between a gateway 44A and a camera 40.

The lower part of FIG. 1 depicts a detailed block diagram of PHY 60, which transmits data to a peer PHY 62 and receives data from the peer PHY over a twisted-pair cable 64. In the present example, cable 64 serves as a zonal link 52. Alternatively, cable 64 may serve as an interzonal link 56 or any other cable in the automotive Ethernet network.

In the transmit direction, PHY 60 receives bits for transmission, from a Medium Access Control (MAC) device (not shown). A symbol mapper 70 maps groups of the received bits (e.g., groups of Nb bits) to respective symbols in accordance with the underlying modulation scheme. A Digital to Analog Converter (DAC) 72 modulates the groups of bits to analog symbols at the required baud rate, and a hybrid module 74 transmits the symbols to the peer PHY via cable 64.

In the receive direction, PHY 60 receives analog symbols carrying bits from peer PHY 62 over cable 64. Hybrid module 74 transfers the received symbols to an Analog to Digital Converter (ADC) 76 that outputs a digital signal. After applying echo cancellation (described below), an Equalizer 78 filters the digital signal to recover the symbols generated by the peer PHY. A slicer 80 recovers the bits conveyed in the received symbols and sends the recovered bits to the MAC device.

PHY 60 comprises an echo canceler 82, for canceling echo signals generated by reflections of the transmitted signal. Such reflections may be caused, e.g., due to imperfect electrical connectors along the path to the peer PHY. The echo canceler receives a sampled signal of the transmitted signal and filters the sampled signal to produce a cancellation signal. A subtractor 84 subtracts the cancellation signal from the digital signal output by ADC 76 so as to produce an echo-suppressed signal input to equalizer 78. Alternatively, the cancellation signal may be inverted (e.g., multiplied by −1) and added to the signal output by the ADC.

In the example of FIG. 1, various elements of the PHY transceiver are configurable depending on the length of the physical link (e.g., cable 64) to which the PHY transceiver connects. To this end, in some embodiments, PHY transceiver 60 comprises a parameter mapper 86, which handles various parameter settings in the PHY transceiver. The parameter mapper may hold predefined parameters such as baud rates, modulation schemes having different modulation orders, and numbers of taps to be used in echo canceler 82 and equalizer 78. PHY transceiver 60 receives or holds the length of cable 64 and selects the actual parameters setting depending on the cable length.

In some embodiments, symbol mapper 70 and slicer 80 support multiple predefined baud rates and modulation schemes having different respective modulation orders. The actual baud rate and modulation scheme used are selected by parameter mapper 86 depending on the cable length. For example, assuming two length categories, e.g., “short cable” and “long cable”, the PHY transceiver is configured to a high baud rate and a low-order modulation scheme when cable 64 is a long cable, and a low baud rate and high-order modulation scheme when cable 64 is a short cable, to reduce power consumption.

In some embodiments, each of equalizer 78 and echo canceler 82 is implemented using a digital filter having multiple taps. The actual number of taps used is determined by parameter mapper 86 depending on the cable length.

Although in the example of FIG. 1, PHY transceiver 60 supports selectable baud rate and modulation scheme, this is not mandatory. In alternative embodiments, a given PHY transceiver may support only one combination of baud rate and modulation scheme in accordance with a given length of cable 64. In these embodiments, multiple different PHY transceivers having different respective baud rate and modulation scheme configurations, may be used within the same automotive network.

Next are described various configurations for connecting elements via zonal links 52 and interzonal links 56.

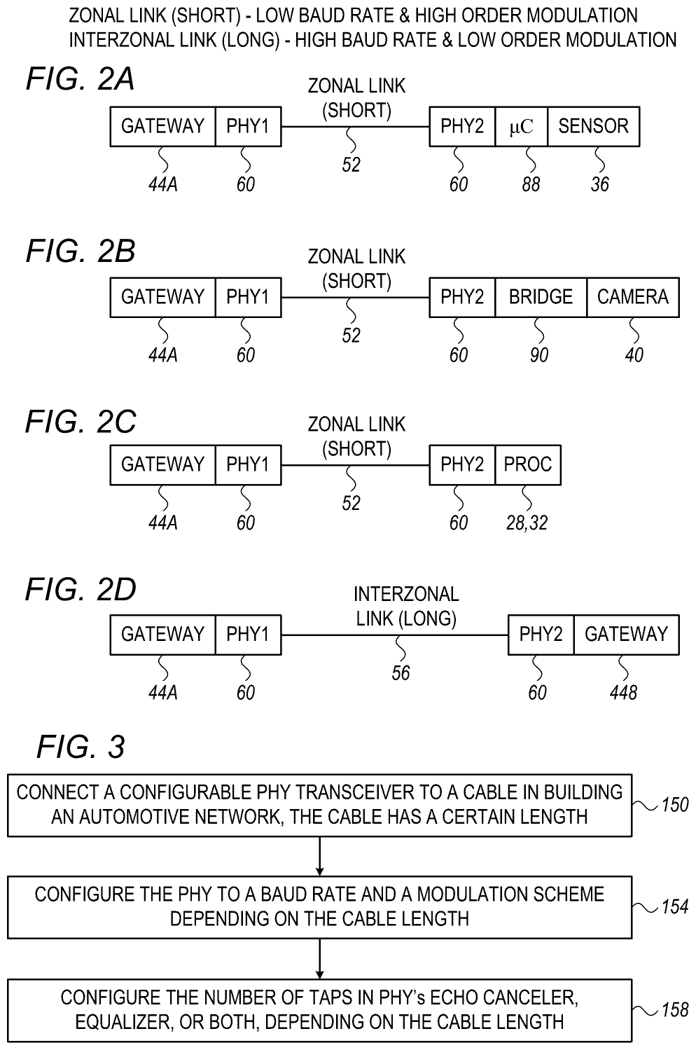

FIGS. 2A-2D are block diagrams that schematically illustrate example schemes for PHY connectivity in the communication system of FIG. 1.

In FIG. 2A, gateway 44A connects via a zonal link 52 to a sensor 36. At the gateway side, a PHY transceiver 60 denoted PHY1 connects the gateway to zonal link 52. At the sensor side, a peer PHY transceiver 60 denoted PHY2 connects the other end of the zonal link to a microcontroller 88 that mediates between PHY2 and the sensor. In an embodiment, microcontroller 88 serves as a Medium Access Control (MAC) controller and is thus also referred to herein as a MAC device, host, or Systems-on-Chip (SoC). In some embodiments, the PHY circuitry and the circuitry that performs MAC functions (e.g., microcontroller 88) are integrated in the same device.

In FIG. 2B, gateway 44A connects via a zonal link 52 to a camera 40. At the gateway side, a PHY transceiver denoted PHY1 connects between the gateway and zonal link 52. At the camera side, a peer PHY transceiver denoted PHY2 connects between zonal link 52 and a bridge device 90 that mediates between PHY2 and the camera.

In FIG. 2C, gateway 44B connects via a zonal link 52 to a central processor, e.g., ADAS 28 or IVI system 28. At the gateway side, a PHY transceiver denoted PHY1 connects between the gateway and zonal link 52. At the central processor side, a peer PHY transceiver denoted PHY2 connects to the relevant processor.

In FIG. 2D, a central gateway 44B connects via interzonal link 56 to a gateway 44A. In this case, PHY transceivers PHY1 and PHY2 connect gateways 44A and 44B to opposite ends of the interzonal link.

In the example of FIGS. 2A-2D the cable length is classified into two length categories, e.g., “a short cable length” for the zonal links, and “a long cable length” for the interzonal links. In this example, a PHY that connects to a long cable is configured to a high baud rate and a low-order modulation scheme, whereas a PHY that connects to a short cable is configured to a low baud rate and a high-order modulation scheme.

The zonal architecture in which the zonal links are relatively short has several advantages as described herein.

As explained above, using short cables allows to reduce the baud rate (and increasing the modulation order), which reduces the power consumption significantly. For example, in a 10 Gigabit PHY, reducing the baud rate from 5.6 bauds to 2.8 bauds (and modifying the modulation scheme from PAM4 to PAM16) may result in about 40% reduction in the power consumption.

Reducing the cable length and the baud rate is also beneficial for echo cancellation, equalization, and mitigating electromagnetic interference, as described herein below.

Regarding echo cancellation, a short cable typically causes a smaller number of reflections than a long cable. Assuming an echo canceler that has a fixed number of taps, the echo canceler performs better and results in improved residual echo signal when using a lower baud rate. Alternatively, with reduced cable length and reduced baud rate, the number of taps in the echo canceler filter may be reduced while maintaining acceptable echo cancellation performance. Reducing the number of echo canceller taps, also reduces implementation complexity, power consumption, and chip area.

As noted above, equalizer 78 is typically implemented using a digital filter having multiple taps. Since a short cable has a lower attenuation than a long cable, reducing the cable length allows to use an equalizer that has a smaller number of taps compared to using a long cable. This too, reduces implementation complexity, power consumption, and chip area.

The communication over an Ethernet link such as links 52 and 56 is subjected to Electromagnetic Interference (EMI) from various sources, which may corrupt electrical signals, such as signals carrying data over Ethernet links (52 and 56), leading to communication errors and system malfunction. Electromagnetic compatibility (EMC) is the ability of a device to operate as intended in its environment without affecting the ability of other devices within the same environment to operate as intended.

In an automotive environment, sources of EMI may reside within a vehicle or externally to the vehicle. External EMI sources include, for example, radio towers, electric power transition lines and airport radar, and many others. EMI sources that are internal to the vehicle include, for example, the vehicle engine and other mechanical and electromechanical components, the windshield wipers, mobile phones, an infotainment system, and the like. Moreover, in a full-duplex bidirectional link, mutual interference may occur between the two communication directions.

Reducing the baud rate for short cables improves both EMI and EMC in various mechanisms as follows:
Since reducing the baud rate reduces the bandwidth, EMI is improved due to reduced exposure to EMI signals, especially high-frequency EMI signals.
With reduced baud rate, the unwanted energy emissions by the PHY transceiver are reduced in out-of-band frequencies.
By using a low baud rate, the immunity of the PHY transceiver to out-of-band EMI improves. For example, with reduced baud rate, a larger band of interfering radar pulses (which are a significant source of EMI) fall out-of-band and can be filtered out.
Due to the improved EMC and EMI, low quality or cheaper cables that are less immune to interference than high quality cables may be used, thereby reducing cost.

Echo canceler 82 and equalizer 78 may be configured to operate in a parallel or non-parallel configuration. In an embodiment, to accommodate high baud rate, the PHY transceiver that connects to a long cable may comprise multiple echo cancelers operating in parallel, which requires a first (high) level of complexity, as well as relatively high power consumption. In this embodiment, due to the reduced baud rate, a PHY transceiver that connects to a short cable comprises a non-parallel echo canceler, which requires a second (low) level of complexity lower than the first level of complexity (and typically lower power consumption).

In another embodiment, to accommodate high baud rate, the PHY transceiver that connects to a long cable comprises multiple equalizers operating in parallel, which requires a first (high) level of complexity. In this embodiment, due to the reduced baud rate, a PHY transceiver that connects to a short cable comprises a non-parallel equalizer, which requires a second (low) level of complexity lower than the first level of complexity.

Parallel implementation (e.g., as described above) may be required because the maximal speed in which various operations such as filtering may be carried out is limited by the underlying silicon manufacturing process. For example, digital filtering with a 28 nm process would typically be slower than the same digital filtering with a 5 nm process. Therefore, depending on the underlying process, PHYs for high-speed baud rate applications may be required to use multiple sub-systems (e.g., filters) operating in parallel with one another, wherein the sub-systems operate at lower rates.

The different elements of communication system 20 and its components, e.g., PHY device 60, may be implemented using dedicated hardware or firmware, such as using hard-wired or programmable logic, e.g., in one or more Application-Specific Integrated Circuits (ASIC) and/or one or more Field-Programmable Gate Arrays (FPGA). Additionally or alternatively, some functions of the components of communication system 20, e.g., of PHY 60, may be implemented in software and/or using a combination of hardware and software elements. Elements that are not mandatory for understanding of the disclosed techniques have been omitted from the figure for the sake of clarity.

In some embodiments, parameter mapper 86 comprises a programmable processor, which is programmed in software to carry out the functions described herein. The software may be downloaded to any of the processor in electronic form, over a network, for example, or it may, alternatively or additionally, be provided and/or stored on non-transitory tangible media, such as magnetic, optical, or electronic memory.

FIG. 3 is a flow chart that schematically illustrates a method for configuring a PHY transceiver in an automotive network, in accordance with an embodiment that is described herein.

The method begins at a connection operation 150, with a network technician (or any other qualified person) connecting a configurable PHY transceiver (e.g., 60) to a cable in building an automotive network. The cable has a certain length in accordance with the distance between the connected elements and the harness design within the vehicle.

At a parameter configuration operation 154, the network technician configures the PHY to a baud rate and a modulation scheme, depending on the cable length. For example, assume that the cables in the automotive network are classified into multiple length categories. For example, with two categories, the cables are classified as either “long cables” (e.g., interzonal links) or “short cables” (zonal links).

In an embodiment, the network technician determines the cable length (or length category) and configures the baud rate and the modulation scheme accordingly. In an embodiment, parameter mapper 86 of PHY 60 holds a predefined mapping that maps between length category and corresponding baud rates and modulation schemes of different modulation orders. The network technician provides the length category of the cable to the PHY transceiver, and the parameter mapper maps the length category to the relevant baud rate and modulation scheme. In general, the mapping maps long cables to high baud rates and low-order modulation schemes, and shorter cables to lower baud rates and high-order modulation schemes.

At a hardware configuration operation 158, the network technician configures the number of taps in the PHY transceiver's echo canceler, equalizer, or both, depending on the cable length. In one embodiment, the parameter mapper holds predefined numbers of taps in the echo canceler and/or equalizer for each respective length category. The network technician provides the length category to the PHY transceiver, and the parameter mapper maps the length category to the relevant number of taps in the echo canceler and/or equalizer. Following operation 158 the method terminates.

Reducing the baud rate may be also useful for communicating over a cable supporting a given low frequency range. For example, consider a cable certified for communication at a data rate of 1 Gigabits per second (Gbps) and that supports a frequency range up to 600 Mega Hertz. Such a cable is typically unsuitable for communication at a data rate of 2.5 Gpbs because the Nyquist sampling rate in this case is 704 Mega Hertz, which is much higher than 600 Mega Hertz. In order to communicate over this cable at a data rate of 2.5 Gbps, the baud rate may be reduced, e.g., by a factor of 5/4 and the modulation scheme modified from PAM4 to PAM5. Consequently, the Nyquist frequency reduces to 704·(4/5)≈560 Mega Hertz, which is supported by the 1 Gbps cable. It is noted that in this example, the baud rate does not depend on the cable length.

The embodiments described above are given by way of example, other suitable embodiments can also be used. For example, in the embodiments above the cable length are mainly classified into two length categories, e.g., long cables and short cables. In alternative embodiments, the cables may be classified into more than two length categories, e.g., long cables, intermediate-length cables, and short cables.

It is noted that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An in-vehicle Ethernet network for data communication within a vehicle, comprising:
a plurality of cables, including at least a first cable having a first length, and a second cable having a second length shorter than the first length;
a first Ethernet transceiver coupled to the longer cable and configured to communicate first symbols over the longer cable at a first baud rate that is commensurate with the first cable length; and
a second Ethernet transceiver, coupled to the shorter cable and configured to communicate second symbols over the shorter cable at a second baud rate that is commensurate with the second cable length and lower than the first baud rate.

2. The in-vehicle Ethernet network according to claim 1, wherein the shorter cable provides one of: (i) a link between a switch and a processor of the in-vehicle Ethernet network, (ii) a link between a switch and a storage device of the in-vehicle Ethernet network, and (iii) a link between a switch and a sensor device of the in-vehicle Ethernet network.

3. The in-vehicle Ethernet network according to claim 1, wherein the longer cable provides a link between two switches of the in-vehicle Ethernet network.

4. The in-vehicle Ethernet network according to claim 1, wherein the first Ethernet transceiver is configured to modulate the first symbols for transmission over the first cable with a first number of bits, and wherein the second Ethernet transceiver is configured to modulate the second symbols for transmission over the second cable with a second number of bits higher than the first number of bits.

5. The in-vehicle Ethernet network according to claim 1, wherein each of the first and second Ethernet transceivers is configured to support both the first baud rate and the second baud rate, and is pre-configured to communicate at the first or second baud rate, respectively.

6. The in-vehicle Ethernet network according to claim 1, wherein the first Ethernet transceiver is configured to support only the first baud rate, and wherein the second Ethernet transceiver is configured to support only the second baud rate.

7. The in-vehicle Ethernet network according to claim 1, wherein the first Ethernet transceiver has a first signal processing capacity, and wherein the second Ethernet transceiver has a second signal processing capacity different from the first signal processing capacity.

8. The in-vehicle Ethernet network according to claim 1, wherein the first Ethernet transceiver comprises a first echo canceler having a first number of taps, and wherein the second Ethernet transceiver comprises a second echo canceler having a second number of taps smaller than the first number of taps.

9. The in-vehicle Ethernet network according to claim 1, the first Ethernet transceiver comprises a first receiver comprising a first equalizer having a first number of taps, and wherein the second Ethernet transceiver comprises a second receiver comprising a second equalizer having a second number of taps smaller than the first number of taps.

10. The in-vehicle Ethernet network according to claim 1, wherein the first Ethernet transceiver comprises multiple echo cancelers operating in parallel requiring a first level of complexity, and wherein the second Ethernet transceiver comprises a non-parallel echo canceler requiring a second level of complexity lower than the first level of complexity.

11. The in-vehicle Ethernet network according to claim 1, wherein the first Ethernet transceiver comprises multiple equalizers operating in parallel requiring a first level of complexity, and wherein the second Ethernet transceiver comprises a non-parallel equalizer requiring a second level of complexity lower than the first level of complexity.

12. The in-vehicle Ethernet network according to claim 1, wherein the first cable and the second cable are of a same cable type.

13. A method for data communication within a vehicle, comprising:
in an in-vehicle Ethernet network comprising at least a first cable having a first length, and a second cable having a second length shorter than the first length,
communicating first symbols over the longer cable, by a first Ethernet transceiver that is coupled to the longer cable, at a first baud rate that is commensurate with the first cable length; and
communicating second symbols over the shorter cable, by a second Ethernet transceiver that is coupled to the shorter cable, at a second baud rate that is commensurate with the second cable length and lower than the first baud rate.

14. The method for data communication according to claim 13, wherein the shorter cable provides one of: (i) a link between a switch and a processor of the in-vehicle Ethernet network, (ii) a link between a switch and a storage device of the in-vehicle Ethernet network, and (iii) a link between a switch and a sensor device of the in-vehicle Ethernet network.

15. The method for data communication according to claim 13, wherein the longer cable provides a link between two switches of the in-vehicle Ethernet network.

16. The method for data communication according to claim 13, wherein communicating the first symbols by the first Ethernet transceiver comprises modulating the first symbols for transmission over the first cable with a first number of bits, and communicating the second symbols by the second Ethernet transceiver comprises modulating the second symbols for transmission over the second cable with a second number of bits higher than the first number of bits.

17. The method for data communication according to claim 13, and comprising, supporting by each of the first and second Ethernet transceivers both the first baud rate and the second baud rate, and pre-configuring each of the first and second Ethernet transceivers to communicate at the first or second baud rate, respectively.

18. The method for data communication according to claim 13, and comprising supporting by the first Ethernet transceiver only the first baud rate, and supporting by the second Ethernet transceiver only the second baud rate.

19. The method for data communication according to claim 13, wherein the first Ethernet transceiver has a first signal processing capacity, and wherein the second Ethernet transceiver has a second signal processing capacity different from the first signal processing capacity.

20. The method for data communication according to claim 13, wherein the first Ethernet transceiver comprises a first echo canceler having a first number of taps, and wherein the second Ethernet transceiver comprises a second echo canceler having a second number of taps smaller than the first number of taps.

21. The method for data communication according to claim 13, wherein the first Ethernet transceiver comprises a first receiver comprising a first equalizer having a first number of taps, and wherein the second Ethernet transceiver comprises a second receiver comprising a second equalizer having a second number of taps smaller than the first number of taps.

22. The method for data communication according to claim 13, wherein the first Ethernet transceiver comprises multiple echo cancelers operating in parallel requiring a first level of complexity, and wherein the second Ethernet transceiver comprises a non-parallel echo canceler requiring a second level of complexity lower than the first level of complexity.

23. The method for data communication according to claim 13, wherein the first Ethernet transceiver comprises multiple equalizers operating in parallel requiring a first level of complexity, and wherein the second Ethernet transceiver comprises a non-parallel equalizer requiring a second level of complexity lower than the first level of complexity.

24. The method for data communication according to claim 13, wherein the first cable and the second cable are of a same cable type.
